(19) United States
(12) Patent Application Publication
(10) Pub. No.: US 2026/0163443 A1
(43) Pub. Date: Jun. 11, 2026

(54) CONNECTION PASSAGE IN A WALL OF A HOUSING

(71) Applicant: iwis mobility systems GmbH & Co. KG, München (DE)

(72) Inventor: Franz STIGLMAIER, München (DE)

(21) Appl. No.: 19/409,602

(22) Filed: Dec. 4, 2025

(30) Foreign Application Priority Data
Dec. 11, 2024 (DE) 102024137101.3

(51) Int. Cl. H02K 5/22; H02K 15/123

(52) U.S. Cl. CPC H02K 5/225; H02K 15/123; H02K 2203/09

(57) ABSTRACT

A connection passage in a wall of a housing, in particular for an electric motor, includes an opening extending through the wall of the housing, at least one connection arranged in the opening extending through the wall of the housing, wherein the connection extends from the interior of the housing to the exterior, and a counterpart arranged in the housing, which covers the opening extending through the wall of the housing at least in some areas in the direction of the interior of the housing, wherein the opening extending through the wall of the housing, the counterpart, and the connection arranged in the opening form a cavity, and wherein the cavity is at least partially filled with a filler material such that a fluid-tight seal is formed between the interior of the housing and the exterior. Furthermore, a housing with at least one such connection passage is provided, an electric motor with this housing, and a method for manufacturing such a connection passage.

### CROSS-REFERENCE TO RELATED APPLICATION

This application claims priority to foreign German patent application No. DE 102024137101.3, filed on Dec. 11, 2024, the disclosure of which is incorporated by reference in its entirety.

### FIELD OF THE INVENTION

The present invention relates to a connection passage in a wall of a housing, in particular for an electric motor, according to the preamble of independent claim 1.

### BACKGROUND

Such a connection passage comprises an opening extending through the wall of the housing, at least one connection arranged in the opening extending through the wall of the housing, wherein the connection extends from the interior of the housing to the exterior, and a counterpart arranged in the housing, which covers the opening extending through the wall of the housing at least in some areas in the direction of the interior of the housing.

EP 2 212 985 B1 already describes a brushless electric motor with an electrical connection protruding from the housing. The electric motor comprises a housing in which a rotor and a stator equipped with coils are arranged. The stator is connected to a switching ring that comprises conductor tracks that supply the coils of the stator with current and control the coils. Each of the conductor tracks is provided with a connection tab. A connection part is provided on the side of the electric motor. The connecting piece comprises openings through which the connection tabs of the conductor tracks are inserted and led outwards. The entire electric motor, i.e., the rotor, the stator, and the switching ring, are overmolded, wherein the connecting piece remains free and protrudes laterally from the electric motor. The connection tabs are simply inserted through the openings in the connecting piece, allowing small particles and liquids to enter and escape from the housing.

DE 10 2021 214 468 A1 shows a pump, in particular a hydrogen pump, with a motor unit. The motor unit comprises a motor housing and an electronics housing, which are separated from each other by a partition wall. An opening is provided in the partition wall through which contacts are routed from the electric machine to the control electronics. A two-part seal is provided to seal the electronics housing. The two-part seal consists of an elastic grommet arranged on the motor side and a curable liquid seal applied on the electronics side. The opening can be designed as a slot to accommodate multiple contacts.

US 2024/0055930 A1 discloses an electronic control unit E1 for an electric motor as used in electric steering systems. A central component is a bearing holder with through holes formed in its end wall. Phase connections of the motor are guided through the through holes. These phase connections are guided through an annular connection carrier or embedded in the connection carrier made of synthetic resin. The connection carrier is arranged on the motor side. Protrusions are formed on the connection carrier, which extend into the through holes. The cavity that forms in the through holes around the phase connections and the protrusions is filled with a liquid sealant. This creates a liquid-tight seal between the protrusions, the through holes, and the phase connections.

### SUMMARY OF THE INVENTION

The object of the present invention is to provide a connection passage in a wall of a housing, in particular for an electric motor, which enables a wider range of applications for the electric motor and can also be used in particular when the housing of the electric motor is filled with a liquid.

This object is solved by the features of independent claim 1.

Accordingly, a solution to the object in accordance with the invention is provided when the opening extending through the wall of the housing, the counterpart, and the connection arranged in the opening form a cavity, wherein the cavity is at least partially filled with a filler material in such a way that a fluid-tight seal is formed between the interior of the housing and the exterior.

This type of connection passage ensures that no liquids or gases can escape from the housing equipped with the connection passage or penetrate the housing from the exterior. This is particularly advantageous in electric motors whose housings are filled with a liquid such as oil. Such an electric motor can be used, for example, in a steering system, especially for trucks.

Advantageous embodiments of the present invention are part of the dependent claims.

According to an advantageous embodiment of the present invention, the filler material is an adhesive that bonds the opening extending through the wall of the housing, the connection arranged in the opening, and the counterpart to each other, so that a fluid-tight seal is formed between the interior of the housing and the exterior. The adhesive forms a material bond with the opening extending through the wall of the housing, i.e., with the outer surface of this opening, the connection, and the counterpart, thereby achieving the desired seal.

In another advantageous embodiment, it may be provided that the cavity formed by the opening extending through the wall of the housing, the counterpart, and the connection arranged in the opening can be filled from the outside. In this way, the filler material or adhesive can be easily filled into the cavity from the exterior, i.e., from the outer side of the housing. Preferably, the cavity formed by the opening extending through the wall of the housing, the counterpart, and the connection arranged in the opening is open on the outer side of the housing, i.e., it comprises an opening through which the adhesive can be filled into the cavity.

In an alternative embodiment, a gap may be provided between the opening extending through the wall of the housing and the counterpart, wherein the gap abruptly increases in size toward the interior of the housing. The abrupt increase in size of the gap creates a tear-off edge for the adhesive. The adhesive therefore does not enter the interior of the housing, but remains in the cavity. The cavity formed by the opening extending through the wall of the housing, the counterpart, and the connection arranged in the opening is thus open on both sides of the wall of the housing, i.e., on the inner side and outer side of the housing, wherein the open area on the outer side of the housing is larger than the open area on the inner side of the housing.

Another advantageous embodiment, particularly when the internal pressure in the motor is higher than the external pressure, may provide that the opening extending through the wall of the housing tapers at least in some areas toward the outer side of the housing. The cross-sectional area of the opening extending through the wall of the housing thus decreases from the interior of the housing toward the exterior, at least in some areas. The base area of the opening is preferably designed as a slotted hole with semicircular ends, and the outer surface of the opening is conical. This can achieve a reinforcement of the sealing effect. When the electric motor is in operation, the liquid in the housing is under pressure and presses the cone-shaped filler material or adhesive against the outer surface of the opening. Alternatively, especially if the motor is operated in an area with higher external pressure than internal pressure, the cone can be mounted in exactly the opposite direction. In this case, the opening extending through the wall of the housing increases, at least in some areas, towards the outer side of the housing. The cross-sectional area of the opening extending through the wall of the housing therefore increases, at least in some areas, from the interior of the housing towards the exterior.

It may also be provided that the opening extending through the wall of the housing comprises a step on the outer side of the housing, such that the cross-sectional area of the opening increases at the step. The step helps to visually limit the filling volume and can serve as an overflow surface or collection volume if too much adhesive is filled in.

Advantageously, it may also be provided that the connection is designed as a connection tab for electrically connecting the coils of an electric motor to a power supply and/or a control system. This ensures a simple and robust power supply.

Additional fixation of the filler material or adhesive in the cavity formed by the opening extending through the wall of the housing, the counterpart, and the connection arranged in the opening, can be achieved if the connection arranged in the opening extending through the wall of the housing comprises a recess extending transversely to the longitudinal extension of the opening extending through the wall of the housing, through which a filler material bridge extends.

In a particularly simple and space-saving design, the counterpart may be designed as a switching ring for contacting the windings of the electric motor. The counterpart, or switching ring, forms a stop on the interior so that the filler material or adhesive cannot slip inwards.

The switching ring advantageously comprises at least one conductor track designed in the manner of a busbar with at least one contact end and at least one connection tab, wherein the at least one conductor track is overmolded with plastic except for the at least one contact end and the connection tab. The plastic overmolding forms a seal along the at least one conductor track.

Another embodiment provides for a protrusion tapering outwardly to be formed at the point where the connection tab exits the switching ring. The protrusion is preferably formed around the circumference of the connection tab. This stabilizes the connection tab at the exit point. In addition, the protrusion can facilitate positioning in the bonding tool and alignment of the opening in the housing and the switching ring with respect to each other.

Another embodiment, for which separate protection can also be claimed, provides for protruding ridges to be formed on the counterpart, which engage with the housing. The ridges are therefore designed as squeeze ribs. These ridges preferably run in a circular arc shape with the motor axis as the arc axis. Other designs are also possible. The ridges can also be designed to run radially away from the motor axis. Preferably, the ridges are interrupted. The ridges engaging with the housing prevent or reduce vibration.

Advantageously, the thickness of the ridges decreases with the ridge height. The ridges can be easily engaged with the housing. It is particularly preferable for the ridges to be deformed by engagement with the housing. Since the thickness of the ridges decreases with the height of the ridges, the ridges can easily deform when they are engaged with the housing. This holds the switching ring firmly in the housing and achieves good vibration reduction.

Furthermore, the present invention also relates to a housing, in particular for an electric motor, with at least one connection passage, preferably at least six connection passages, according to one of claims 1 to 13. The housing then comprises a simple and secure seal for the connection passages, ensuring that no liquid can escape from the interior of the housing to the exterior.

The invention also relates to an electric motor comprising a housing according to claim 14. The housing of the electric motor thus comprises at least one connection passage as described above, preferably at least six of the connection passages described above. The connection passages ensure that the exit points of the connections, preferably the electrical connections, of the electric motor are sealed in a fluid-tight manner from the housing. This is particularly important when the housing of the electric motor is filled with oil in order to achieve a seal against the electronics.

In an advantageous embodiment of the electric motor, the at least one connection tab may be arranged parallel to the motor axis of the electric motor. This results in a compact design of the electric motor.

Simple manufacturing and assembly, yet secure sealing, can be achieved if at least one of the connection passages is formed in a bearing shield of the electric motor. As already described, the housing of the electric motor is at least partially filled with oil. This is the case, for example, when the electric motor is part of a steering system and drives a hydraulic unit. The housing is partially open on one side. This avoids the need for a technically sophisticated seal to the pump (sealing the shaft and dry-running bearings). It also cools the electric motor. When the electric motor is in operation, the temperature of the oil increases, the oil becomes thinner, and a seal to the electronics is particularly important.

Furthermore, the invention also relates to a method for producing a connection passage in a wall of a housing, in particular for an electric motor, according to one of claims 1 to 13, comprising the following steps:
Positioning a housing with an opening extending from the interior to the exterior through a wall of the housing, a connection extending through the opening of the housing, and a counterpart relative to each other such that the opening extending through the wall of the housing, the counterpart, and the connection arranged in the opening form a cavity,
wherein the connection extends through the cavity,
injecting a plastic material into the cavity,
curing the plastic material so that the interior of the housing is sealed against the exterior in a fluid-tight manner.

This is an easy way to ensure that the connection from the housing to the exterior is fluid-tight. This is particularly important if the housing is partially open, allowing a fluid such as oil to enter the electric motor. It must then be ensured that a reliable seal can be achieved with the electronics of the electric motor. This is achieved by the adhesive, which forms a material bond with the surface of the opening, the counterpart, and the connection.

In one variant of the method, the counterpart may be positioned relative to the opening extending through the wall of the housing in such a way that a gap is formed between the opening extending through the wall of the housing and the counterpart, wherein the gap abruptly increases in size toward the interior of the housing. This abrupt increase in the cross-section of the gap towards the interior of the housing forms a tear-off edge for the adhesive. The adhesive does not flow further at the tear-off edge, or rather does not flow through this gap, so that the adhesive is reliably prevented from penetrating into the interior of the housing.

In yet another advantageous variant of the method, the counterpart may be designed as a switching ring comprising at least one conductor track with a connection tab designed as a connection, wherein the conductor track is overmolded with plastic except for the connection tab, and wherein the positioning of the switching ring with the connection tab relative to the opening extending through the wall of the housing is effected by means of conical protrusions formed at the point where the connection tab exits the switching ring. The conductor tracks may also comprise contact ends for contacting the coils of the electric motor, which are also not overmolded with plastic. The switching ring already present in the electric motor therefore performs an additional function, namely forming a counterpart to the opening in the housing wall, by means of which the gap forming the tear-off edge is adjusted.

A simple variant of the process can be achieved by curing the plastic using light, preferably UV light. For example, UV lamps can be positioned at the adhesive filling point, which are used to irradiate the plastic with UV light and cause it to cure.

In another advantageous variant of the method, it may be provided that the plastic is cured by means of at least one further method, preferably by means of moisture curing or heat curing. This is particularly advantageous if the cavity into which the adhesive is filled comprises undercuts, etc., in which shadows form when irradiated with UV light. The use of a second curing process, i.e., dual curing, ensures that the adhesive is cured reliably in all areas of the cavity.

### BRIEF DESCRIPTION OF THE DRAWINGS

The invention is described in more detail below with reference to the figures.

FIG. 1: Perspective view of an electric motor according to the invention from above,

FIG. 2: Perspective view of the electric motor from FIG. 1 from below,

FIG. 3: Cross-section through the electric motor from FIG. 1 along line III-III,

FIG. 4: Enlargement of a detail from FIG. 3,

FIG. 5: Top view of a bearing shield of the electric motor from FIG. 1,

FIG. 6: Underside view of the bearing shield of the electric motor from FIG. 1,

FIG. 7: Section through the bearing shield from FIG. 5 along line VII-VII,

FIG. 8: Enlargement of a detail from FIG. 7,

FIG. 9: Perspective view of a switching ring of the electric motor from FIG. 1,

FIG. 10: Section through the switching ring from FIG. 9 along line X - X,

FIG. 11: Enlargement of a detail from FIG. 10.

### DETAILED DESCRIPTION

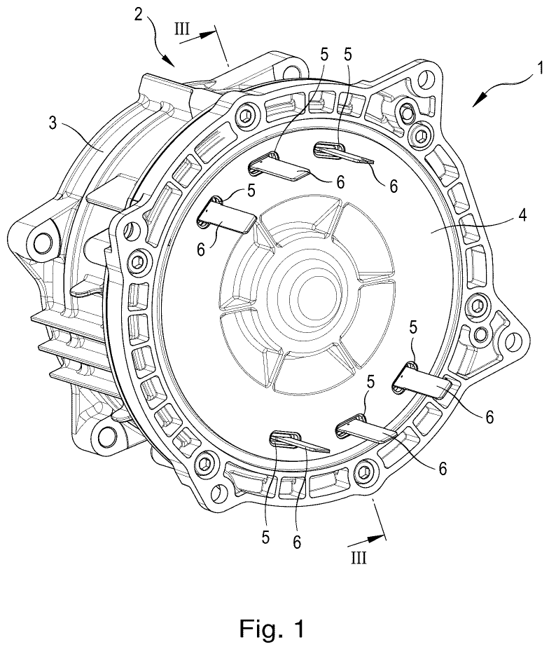

FIG. 1 shows a perspective view of an electric motor 1 from above. The electric motor 1 has a housing 2 comprising a housing body 3 and a bearing shield 4. The housing body 3 is essentially pot-shaped and open on one side. The bearing shield 4 is attached to the open side of the housing body 3. The bearing shield 4 is preferably screwed to the housing body 3. Six connection passages 5 are formed in the bearing shield 4. Six electrical connections of the electric motor 1, designed as connection tabs 6, exit the electric motor 1 at the connection passages 5. The connection passages 5 seal the interior of the housing 2 fluid-tight from the exterior. The connection tabs 6 are connected to electronics located outside the housing 2 and are used to supply power and control the coils of the electric motor 1.

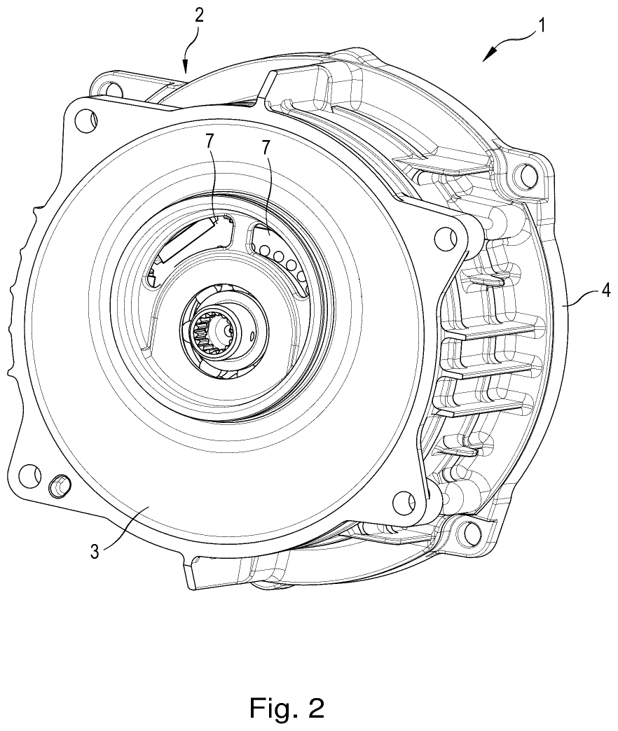

FIG. 2 shows a perspective view of electric motor 1 from FIG. 1 from below. The electric motor 1 drives a hydraulic unit as part of a steering system for trucks. The housing 2 or housing body 3 comprises inlet openings 7 at its underside to allow oil to enter the electric motor. The electric motor 1 therefore runs in oil.

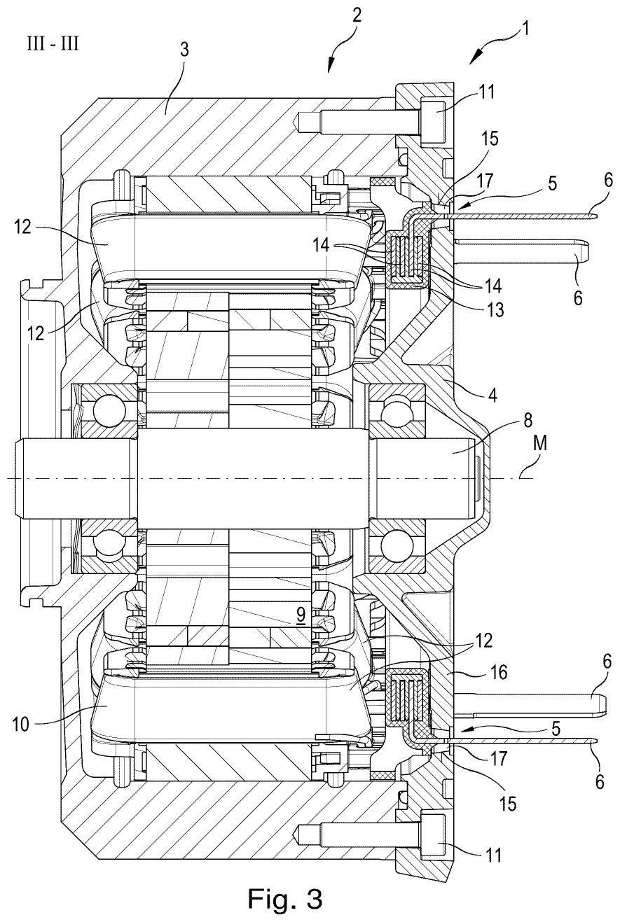

FIG. 3 shows a cross-section of the electric motor 1 from FIG. 1 along line III-III. As already described, the electric motor 1 comprises a housing 2 with a housing body 3 and a bearing shield 4. The bearing shield 4 is screwed to the housing body 3 by means of screws 11. A rotor 9 and a stator 10 are arranged in the housing 2. The stator 10 comprises a plurality of coils 12, and the rotor 9 comprises rotor laminations equipped with permanent magnets, which are fastened to a motor shaft 8. A switching ring 13 is attached to the stator 10 and serves to contact the coils 12. For this purpose, the switching ring 13 comprises a plurality of conductor tracks 14, in this case four, in the manner of a busbar. The conductor tracks 14 are designed as thin metal strips made of an electrically conductive material and comprise contact ends for contacting the coils 12 and/or connection tabs 6. The conductor tracks 14 are electrically insulated from each other in the switching ring 13. This is preferably achieved by means of a plastic material, for example a plastic overmolding. All conductor tracks 14 are overmolded with plastic except for the contact ends and the connection tabs 6. The contact ends and the connection tabs 6 are not covered by plastic but protrude from the plastic overmolding. The switching ring 13 is arranged adjacent to the bearing shield 4. Openings 15 are formed in the bearing shield 4, which extend completely through the wall 16 of the bearing shield 4. The openings 15 therefore form a connection from the interior of the housing 2 to the outer side of the housing 2. The connection tabs 6 are arranged in the openings 15. The connection tabs 6 extend from the bearing shield 4 through the openings 15 in the bearing shield 4 to the outer side of the housing 2 or the bearing shield 4. The bearing shield 4, the opening 15 extending through the wall 16 of the bearing shield 4, and the connection tab 6 arranged in the opening 15 form a cavity 17. The cavity 17 is filled with a filler material (not shown) so that a fluid-tight seal of the housing 2 or the bearing shield 4 to the exterior is achieved. The bearing shield 4, the opening 15 extending through the wall 16 of the bearing shield 4, the connection tab 6 arranged in the opening 15, and the filler material arranged in the cavity 17 thus form a fluid-tight connection passage 5. The electric motor according to the embodiment shown comprises six such connection passages 5. All six connection passages 5 are identical to each other.

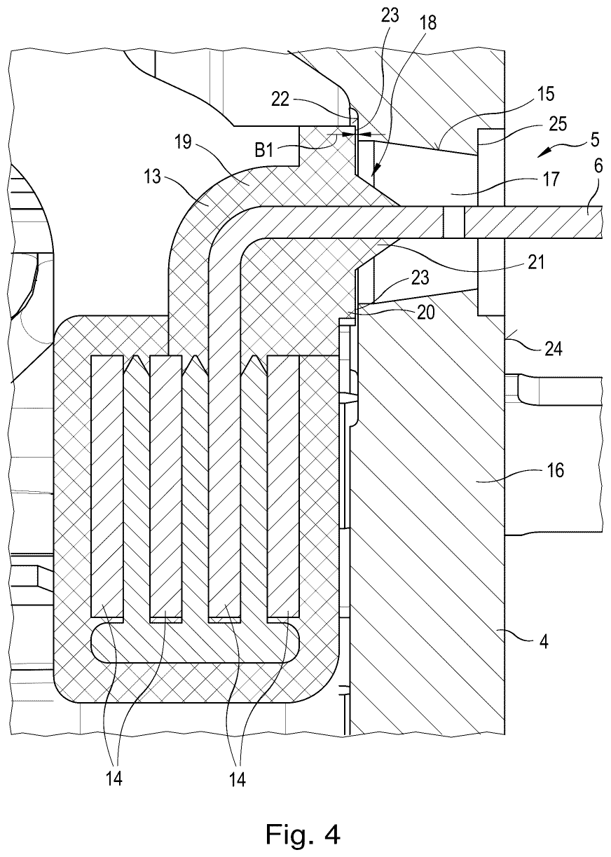

FIG. 4 shows a detail from FIG. 3, an enlarged view of a connection passage 5 in section. As already described, the switching ring 13 is arranged adjacent to the bearing shield 4. The connection tabs 6 of the conductor tracks 14 of the switching ring 13 extend through the openings 15 in the bearing shield 4. One connection tab 6 extends through each of the openings 15. A circumferential plateau 20 is formed at the exit point 18 of the connection tab 6 from the plastic overmolding 19 of the switching ring 13. The plateau 20 protrudes beyond the main surface of the switching ring 13 facing the bearing shield 4. The plateau 20 is preferably part of the plastic overmolding 19. Preferably, the plateau 20 comprises a uniform thickness. The plateau 20 surrounds the connection tab 6 all the way around. A protrusion 21 that tapers outward is formed on the plateau 20. The protrusion 21 is formed all the way around the respective connection tab 6 and surrounds the connection tab 6 on all sides. The connection tab 6 and the protrusion 21 are arranged centrally in the opening 15 extending through the wall 16 of the bearing shield 4. The switching ring 13, or the plateau 20 of the switching ring 13, does not lie directly against the inner side 22 of the bearing shield 4, but is arranged at a slight distance from the inner side 22 of the bearing shield 4. This creates a gap 23 between the switching ring 13, in particular the plateau 20 of the switching ring 13, and the inner side 22 of the bearing shield 4 surrounding the opening 15. Starting from the opening 15, which extends through the bearing shield 4, the gap 23 initially has a very small gap width B1. The maximum gap width depends on the viscosity of the adhesive. Preferably, the gap width B1 is less than 0.5 mm. The width of the gap 23 then increases abruptly towards the interior of the housing 2. Preferably, the width of the gap increases to approximately three to four times the gap width B1. This is achieved by the plateau 20, which protrudes above the main surface of the switching ring 13.

The connection tab 6 is arranged in the opening 15 extending through the wall 16 of the bearing shield 4 and protrudes from the opening 15. Starting from its end facing the switching ring 13, the opening 15 initially has a straight course. The opening 15 then tapers outward. In this area, the opening 15 is therefore conical in shape. Starting from the outer side 24 of the bearing shield 4, a step 25 is formed in the opening 15. At the step 25, the cross-sectional area of the opening 15 increases abruptly. Following the step 25, the opening 15 has a straight course again.

As can be clearly seen in FIG. 4, the switching ring 13, in particular the plateau 20 of the switching ring 13 and the protrusion 21 formed thereon, the opening 15 extending through the wall of the bearing shield, and the connection tab 6 arranged in the opening 15, form the cavity 17. The cavity 17 is open at both ends and comprises a first opening facing the interior of the housing 2 and a second opening facing the exterior, formed on the outer side of the housing 2. The inward-facing first opening is formed by the gap 23. The area of the first opening is therefore significantly smaller than the area of the second opening. The cavity 17 is filled with a filler material (not shown). This achieves a fluid-tight seal of the connection passage 5 and thus a fluid-tight seal of the interior of the housing 2 to the exterior. Preferably, the filler material is an adhesive.

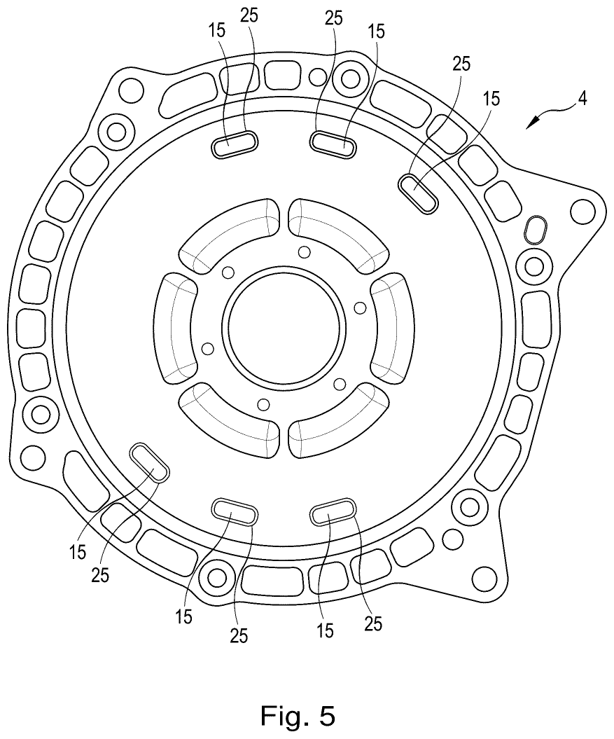

FIG. 5 shows a top view of another embodiment of the bearing shield 4. The bearing shield according to FIG. 5 to FIG. 8 differs from the bearing shield shown in FIG. 1 to FIG. 4 in that the bearing shield 4 is open in the area of the motor shaft 8. A separate cover is attached there, e.g., screwed on. This is not shown in FIGS. 5 to 8. In FIGS. 1 to 4, this separate cover is integrated into the bearing shield. The bearing shield in FIGS. 1 to 4 is therefore designed as a closed variant. The bearing shield 4 is essentially circular. As already described, the bearing shield 4 comprises six openings 15 for receiving the connection tabs of the switching ring. Three openings 15 are grouped together in each case, with the two groups of openings facing each other. The cross-sectional area of each of the openings 15 has the shape of an elongated hole with two parallel longitudinal sides, each of which is terminated at its ends by a semicircle. In each of the openings 15, the step 25 is formed towards the outside, which represents an abrupt increase in the cross-sectional area of the opening 15.

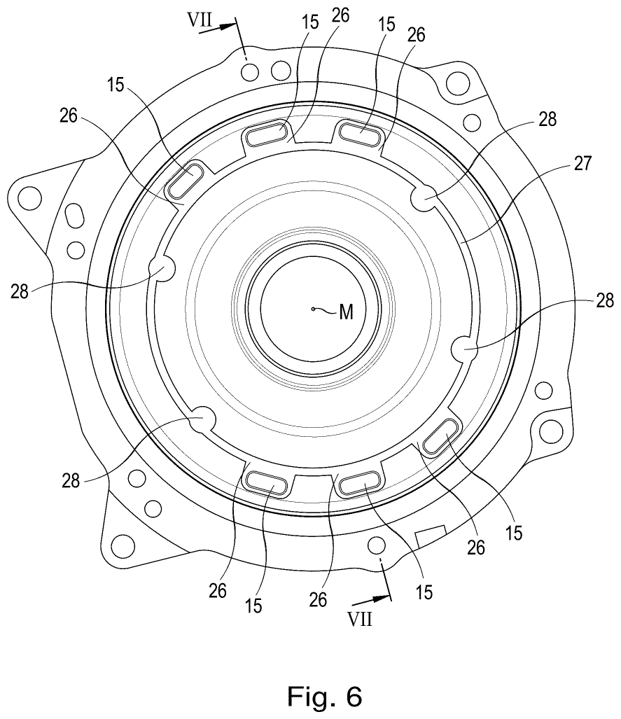

FIG. 6 shows a view from below of the bearing shield 4. The six openings 15 in the bearing shield 4 are each surrounded by a recess 26. The recesses are not strictly necessary. However, a high degree of precision is required on this surface. The surface not only forms the gap between the bearing shield 4 and the plateaus 20 and the four other contact surfaces on the switching ring 13 for assembly, but is also the contact surface for ridges or squeeze ribs, which will be described in more detail below. This surface is therefore machined, which is shown here as recess 26. The respective plateau 20 of the switching ring 13 is arranged in the recesses 26 when the bearing shield 4 is attached to the housing body 3. In addition, a circumferential circular groove 27 is formed on the inner side of the bearing shield 4. The circular groove 27 is arranged closer to the motor axis M than the openings 15. The recesses 26 around the openings 15 merge into the circular groove 27. Four circular recesses 28 are formed on the inner side of the bearing shield 4, which lie at least partially in the circular groove 27.

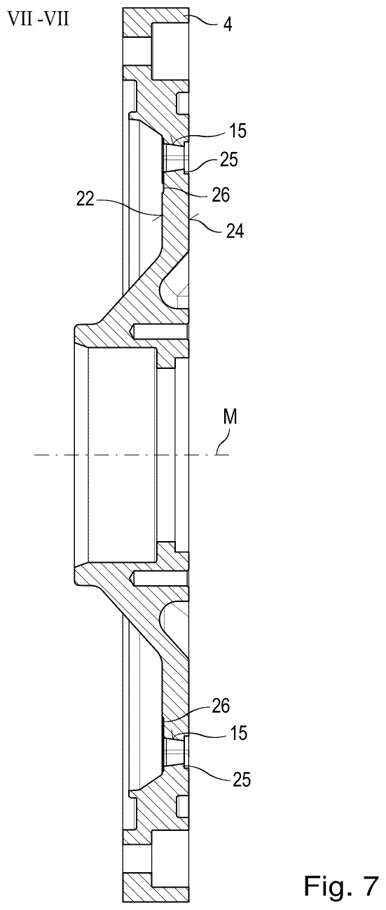

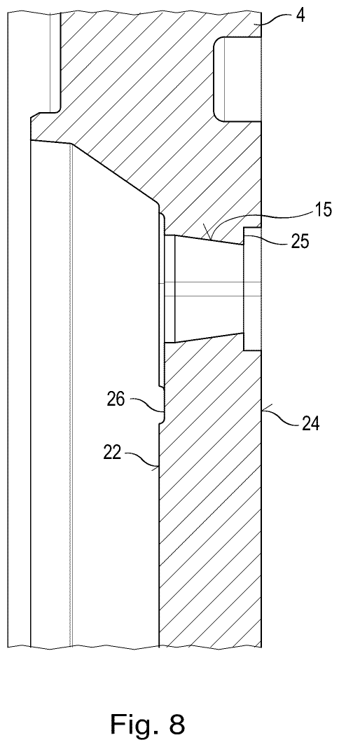

FIG. 7 shows a section through the bearing shield 4 along line VII-VII in FIG. 6, FIG. 8 shows an enlargement of one of the openings 15 in the section. Starting from its end located on the inner side 22 of the bearing shield 4, the opening 15 initially has a straight course. The opening 15 then tapers outward. The cross-sectional area of the opening 15, i.e., the area perpendicular to the motor axis M, decreases toward the exterior. In this area, the opening 15 is therefore conical in shape. Starting from the outer side 24 of the bearing shield 4, the step 25 is formed in the opening 15. At the step 25, the cross-sectional area of the opening 15 increases abruptly. Following the step 25, the opening 15 has a straight course again. On the inner side of the bearing shield 4, the recess 26 is formed around the opening 15.

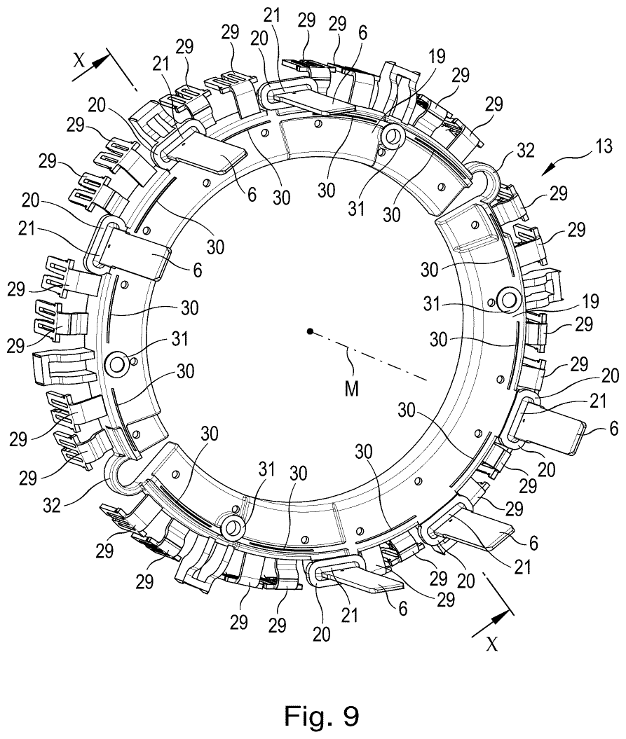

FIG. 9 shows a perspective view of the switching ring 13. The switching ring 13 is formed from two essentially identical halves. The two halves of the switching ring are connected to each other by means of an elastic element 32. Each of the halves comprises conductor tracks 14, each with a connection tab 6 and/or contact ends 29. In particular, the embodiment shown provides for three conductor tracks, each with a connection tab 6 and two contact ends 29, and one conductor track with six contact ends 29 and no connection tab. The conductor tracks 14 are provided with a plastic overmolding 19 except for the connection tabs 6 and the contact ends 29. The plastic overmolding 19 thus forms an electrically insulating body from which the connection tabs 6 and the contact ends 29 protrude. Preferably, the conductor tracks 14 comprise an arcuate region, wherein the center of curvature of the arcuate regions lies on the motor axis M. The arcuate regions of the conductor tracks 14 extend perpendicular to the motor axis. The connection tabs 6 and/or the contact ends 29 are angled away from the arcuate regions and extend preferably parallel to the motor axis M. During operation of the electric motor 1, the oil in the housing 2 heats up and the viscosity of the oil decreases. If a gap is formed between the conductor tracks 14 and the plastic overmolding 19, the oil creeps into this gap. The oil can then creep along the conductor tracks 14 and escape at the respective connection tab 6. A sealing effect is achieved by the bonding between the connection tab 6 and the opening 15. The bonding to the plastic, i.e., the exit point of the connection tab 18 and the plateau 20, serves to improve the strength of the connection.

The plateaus 20 are formed at the points where the connection tabs 6 emerge from the plastic injection molding 19. The plateaus 20 protrude beyond the main surface of the switching ring. In addition, each connection tab 6 is surrounded by a tapered protrusion 21.

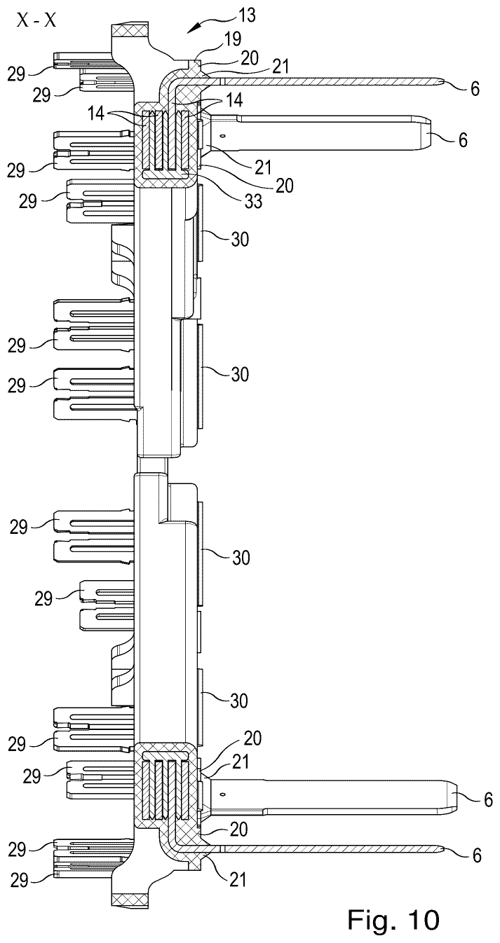

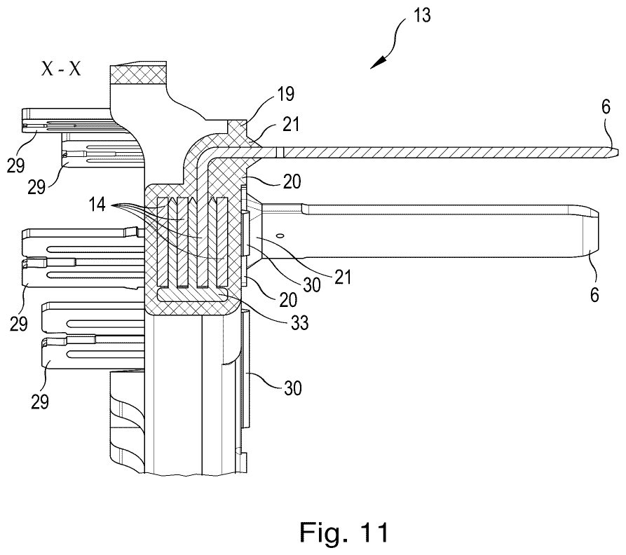

Arcuate ridges 30 are formed on the side of the switching ring 13 facing the bearing shield 4. When the electric motor 1 is assembled, the arcuate ridges 30 engage with the housing 2 and the bearing shield 4. The ridges 30 are therefore designed as squeeze ribs. The ridges 30 are arranged in the circular groove 27 in the bearing shield 4. The ridges 30 run in a circular arc with the motor axis as the arc axis. The ridges 30 are interrupted. Alternative designs of the ridges are also possible. For example, the ridges can also be designed so that they run radially away from the motor axis M. Since the ridges 30 engage with the housing 2, vibration avoidance or reduction is achieved. The thickness of the ridges 30 decreases with the ridge height. This is shown in particular in FIGS. 10 and 11. The ridges 30 can therefore be easily engaged with the housing 2. The ridges 30 are deformed by engaging with the housing 2. Since the thickness of the ridges 30 decreases with the ridge height, the ridges 30 can easily deform when they are engaged with the housing 2. This holds the switching ring 13 firmly in the housing 2 and achieves good vibration reduction. Furthermore, the switching ring comprises circular protrusions 31. These protrusions 31 serve to ensure precise positioning during assembly.

FIG. 10 shows a cross-section through the switching ring 13 along line X-X in FIG. 9, FIG. 11 shows an enlargement of one of the connection tabs 6 in the cross-section. The connection tabs 6 are designed as elongated rectangular elements. Eight conductor tracks 14 are arranged adjacent to each other in the switching ring 13. Six of the conductor tracks 14 comprise a connection tab 6, while two of the conductor tracks 14 do not have a connection tab. All conductor tracks 14 are overmolded with plastic except for the connection tabs 6 and the contact ends 29. Furthermore, a plastic insert or retaining part 33 may be provided in which the conductor tracks 14 are inserted. The retaining part 33 with the conductor tracks 14 inserted therein is then provided with the plastic overmolding 19. The plastic overmolding 19 and/or the retaining part 33 electrically insulate the conductor tracks 14 from one another. In order to improve the adhesive force of the connection tabs 6 with the filler material or adhesive that is introduced into the cavity 17, it may be provided that the surface of the connection tabs in this area, i.e., in the area in which the connection tabs extend through the opening 15 of the bearing shield 14, is treated. One possible solution would be to increase the surface roughness. In addition, a seal could be fitted onto the connection tabs 6. The seal can be located in the area of the respective connection tab 6 that is surrounded by the plastic injection molding 19. The seal is then injected into the plastic injection molding 19. It is also possible to provide a seal that is attached to the area of the connection tabs 6 that extends out of the plastic injection molding 19. This seal rests against the plastic overmolding 19 and is adapted in shape to the tapered or conical protrusion 21 of the switching ring 13. This provides additional sealing of the connection tabs 6, in particular emergency sealing in the event of a possible defect in the connection between the connection tab and the adhesive.

The following describes a method for manufacturing a connection arrangement as described above. In this method, the housing 2, in particular the bearing shield 4 with the opening 15 extending outward through a wall of the housing or bearing shield 4, the connection extending through the opening 15 of the housing or bearing shield 4, i.e., the connection tab 6, and a counterpart, in this case the switching ring 13, are positioned relative to each other so that the connection tab 6 extends to the exterior through the opening 15. The opening 15 extending through the wall of the housing or bearing shield 4, the switching ring 13, and the connection tab 6 form the cavity 17. The connection tab 6 extends to the exterior through the cavity 17.

A filler material, preferably an adhesive, is then injected into the cavity 17. Preferably, the filler material or adhesive is injected into the cavity 17 from the exterior, i.e., from the outer side of the bearing shield 4. The plastic injected into the cavity 17 is then cured so that the interior of the housing 2 is sealed against the exterior in a fluid-tight manner. Curing can be initiated by irradiation with light, preferably UV light. Dual curing may also be provided. In this case, the curing of the adhesive is initiated by two different curing methods. In particular, a combination of light curing (UV) and moisture curing or heat curing is possible.

When positioning the switching ring 13 and the bearing shield 4 in relation to each other, the switching ring 13 and the bearing shield 4 are arranged such that a gap 23 is formed between the opening 15 extending through the wall of the bearing shield 4 and the switching ring 13, wherein the gap 23 abruptly increases in size toward the interior of the housing 2.

As already described, the conductor tracks 14 are overmolded with plastic, except for the connection tab 6. A tapered or conical protrusion 21 is formed at the exit point 18 of the connection tab from the plastic overmolding 19 of the switching ring 13. The switching ring (via radial squeeze ribs) and the bearing shield (via a centering collar) position themselves in the housing 3 at the bore for the stator press fit. The position of the angular position is only controlled during assembly.

The adhesive is cured using light, preferably UV light. UV lamps are provided for this purpose. The UV lamps can be located at the plastic injection point. As already described, the adhesive is preferably cured using two different curing methods (dual curing). In particular, a combination of light curing (UV) and moisture curing or heat curing can be used here.

Preferably, the stator 10 with the switching ring 13 attached to it and the rotor are already mounted in the housing 2 or the housing body 3, and the bearing shield 4 is attached to the housing body 3 before the connection passage 5 is manufactured.

### LIST OF REFERENCE SIGNS

1 Electric motor
2 Housing
3 Housing body
4 Bearing shield
5 Connection passage
6 Connection tab
7 Inlet opening
8 Motor shaft
9 Rotor
10 Stator
11 Screws
12 Coil
13 Switching ring
14 Conductor track
15 Opening
16 Wall bearing shield
17 Cavity
18 Exit point connection tab
19 Plastic overmolding switching ring
20 Plateau
21 Protrusion switching ring
22 Inner side bearing shield
23 Gap
24 Outer side bearing shield
25 Step
26 Recess
27 Circular groove on the inner side of the bearing shield
28 Circular recess on the inner side of the bearing shield
29 Contact end
30 Arcuate ridge
31 Circular protrusions
32 Elastic element switching ring
33 Retaining part
B1 Width of gap 23
M Motor axis

1. A connection passage in a wall of a housing, in particular for an electric motor, comprising:
an opening extending through the wall of the housing,
at least one connection arranged in the opening extending through the wall of the housing, wherein the connection extends from the interior of the housing to the exterior, and
a counterpart arranged in the housing which covers the opening extending through the wall of the housing at least in some areas in the direction of the interior of the housing,
wherein the opening extending through the wall of the housing, the counterpart, and the connection arranged in the opening form a cavity, wherein the cavity is at least partially filled with a filler material such that a fluid-tight seal is formed between the interior of the housing and the exterior.

2. The connection passage according to claim 1, wherein the filler material is an adhesive which bonds the opening extending through the wall of the housing, the connection arranged in the opening, and the counterpart to each other, so that a fluid-tight seal is formed between the interior of the housing and the exterior.

3. The connection passage according to claim 1, wherein the cavity formed by the opening extending through the wall of the housing, the counterpart, and the connection arranged in the opening is fillable from the exterior.

4. The connection passage according to claim 1, wherein the counterpart is arranged in the housing in such a way that a gap is formed between the opening extending through the wall of the housing and the counterpart, wherein the gap abruptly increases in size toward the interior of the housing.

5. The connection passage according to claim 1, wherein the opening extending through the wall of the housing tapers at least in some areas toward the outer side of the housing.

6. The connection passage according to claim 1, wherein the opening extending through the wall of the housing comprises a step on the outer side of the housing such that the cross-sectional area of the opening increases at the step.

7. The connection passage according to claim 1, wherein the connection is designed as a connection tab for electrically connecting the coils of the electric motor to a power supply and/or a control system.

8. The connection passage according to claim 1, wherein the connection arranged in the opening extending through the wall of the housing comprises a recess extending transversely to the longitudinal extension of the opening extending through the wall of the housing, through which a filler material bridge extends.

9. The connection passage according to claim 1, wherein the counterpart is designed as a switching ring for contacting the windings of the coils of the electric motor.

10. The connection passage according to claim 9, wherein the switching ring comprises at least one conductor track designed in the manner of a busbar with at least one contact end and at least one connection tab, wherein the at least one conductor track is overmolded with plastic except for the at least one contact end and the connection tab.

11. The connection passage according to claim 1, wherein protruding ridges are formed on the switching ring, the protruding ridges engage with the housing.

12. The connection passage according to claim 11, wherein the thickness of the ridges decreases with the ridge height.

13. The connection passage according to claim 11, wherein the ridges are deformed by engagement with the housing.

14. A housing, in particular for an electric motor, with at least one connection passage, preferably with six connection passages, according to claim 1.

15. The electric motor comprising a housing according to claim 14.

16. The electric motor according to claim 15, wherein the at least one connection tab is arranged parallel to the motor axis (M) of the electric motor.

17. The electric motor according to claim 15, wherein at least one connection passage is formed in a bearing shield of the electric motor.

18. A method for producing a connection passage in a wall of a housing, in particular for an electric motor, according to claim 1, comprising the following steps:
positioning a housing with an opening extending to the exterior through a wall of the housing, a connection extending through the opening of the housing, and a counterpart relative to each other in such a way that the opening extending through the wall of the housing, the counterpart, and the connection arranged in the opening form a cavity, wherein the connection extends through the cavity,
injecting a plastic material into the cavity,
curing the plastic material in such a way that the interior of the housing is sealed against the exterior in a fluid-tight manner.

19. The method according to claim 18, wherein the counterpart is positioned relative to the opening extending through the wall of the housing in such a way that a gap is formed between the opening extending through the wall of the housing and the counterpart, wherein the gap abruptly increases in size toward the interior of the housing.

20. The method according to claim 18, wherein the counterpart is designed as a switching ring which comprises at least one conductor track with a connection tab designed as a connection, wherein the conductor track is overmolded with plastic except for the connection tab, and wherein the positioning of the switching ring with the connection tab relative to the opening extending through the wall of the housing is effected by means of conical protrusions formed at the exit point of the connection tab from the switching ring.

21. The method according to claim 18, wherein the plastic material is cured by means of light, preferably by means of UV light.

22. The method according to claim 21, wherein the plastic material is cured by means of at least one further method, preferably by means of moisture curing or heat curing.
